(19) United States
(12) Patent Application Publication
(10) Pub. No.: US 2023/0191628 A1
(43) Pub. Date: Jun. 22, 2023

(54) A GRIPPING TOOL, A SYSTEM, A CLAMPING UNIT, AND A METHOD OF HANDLING OBJECTIONS IN A PROCESS

(71) Applicant: FYNBO ENGINEERING IVS, Gudbjerg Sydfyn (DK)

(72) Inventor: Jens Fynbo, Gudbjerg Sydfyn (DK)

(21) Appl. No.: 17/913,127

(22) PCT Filed: Mar. 22, 2021
(86) PCT No.: PCT/DK2021/050085

§ 371 Date: Sep. 20, 2022

(30) Foreign Application Priority Data
Mar. 20, 2020 (DK) PA 2020 70177

(51) Int. Cl. B25J 15/10; B25J 15/00; B23B 31/12

(52) U.S. Cl. CPC B25J 15/103; B25J 15/0033; B23B 31/1269

(57) ABSTRACT

A gripping tool (2), a system, a clamping unit (35) and a method of handling objects (6), where the gripping tool (2) comprises a transmission mechanism arranged in a housing (7), wherein the transmission mechanism is coupled to a plurality of arms (11) located outside the housing (7). The arms (11) extend in a radial plane from a first end (15) to a second end (16), where one or more gripping fingers (12) are arranged on each arm (11). The gripping fingers (12) may be repositioned on the arm (11), or multiple gripping fingers (12) may be arranged on the same arm (11). The arm (11) preferably has a bent or curved profile where the bending line or curvature is facing a central longitudinal axis (A) of the housing (7).

### FIELD OF THE INVENTION

The present invention relates to a gripping tool, preferably a gripper with multiple gripping elements, configured to be coupled to an arm of a machine or to be arranged on a surface, wherein the gripping tool comprising a plurality of arms rotatable connected to a housing of the gripping tool, each arm has at least one gripping point for gripping an object.

### BACKGROUND OF THE INVENTION

It is known that to use gripping tools mounted on a robotic arm of a robot to handle objects during assembly, processing, sorting and packaging. The gripping tool is fitted with two or more gripping arms each designed to grip a particular object at a gripping point. The gripping arms are configured to move between various positions during the gripping process, wherein the operation of the gripping tool is controlled by a local controller in the robot unit. Optionally, the local controller may receive commands from a central controller.

It is known that the robotic arms, including their respective interfaces, are fitted with one or more joints each providing the robotic arm with at least one degree of freedom (DOF). Typically, the robotic arm has between five to seven DOFs, but some robotic arms have only two or three DOFs. The design of the gripping tool, as well as the robot unit, is selected based on the size, shape and weight of the objects intended to be handled by the robot unit.

It is known to use sensors and/or cameras for monitoring the axial movement of the robotic arm and thus the gripping tool. The signals from these sensors or cameras are then used by the local controller to correctly positioning the gripping arms relative to a particular object. The local controller may alternatively use a two- or three-dimensional map of the objects to position the gripping tool.

US 2013/0341944 A1 from Robert Bosch GmbH discloses a gripping device for a handling robot provided with a protective device, where the gripping device comprises three arms all connected to a common transmission mechanism arranged within the housing of the gripping device. Each arm has an elongated body extending in the radial plane where one end is connected to a rotating shaft of the transmission mechanism by a clamping arrangement and the other end is connected to a gripping finger. The gripping finger is connected to the arm by means of a snap-in coupling.

The arms have to be manually exchanged with longer arms in order to grip very large objects.

EP 2390068 B1 by Schunk GmbH discloses a gripping device with three arms all connected with a pneumatically operated transmission mechanism, where each arm has an L-shaped body where the bend between the legs faces outwards from a central longitudinal axis. One leg of the arm is connected to a rotating shaft of the transmission mechanism while the other leg of the arm is at the free end connected to a gripping finger. The gripper finger is arranged on that side of the arm which is rotated into contact with an object. The arm is fixed relative to the rotation shaft by a locking pin arranged in a recess in both the rotation shaft and the arm. It is stated that this gripping device can grip circular objects with an outer diameter between 0-100 mm and annular objects with inner diameter between 10-125 mm.

However, EP 2390068 B1 is silent about how the gripping fingers are held in place in the respective arms, nor does it hint or suggest that the gripping fingers can be exchanged. The illustrated configuration suggests that the gripping fingers are firmly attached to the arm, or form an integrated part of the arm.

Another example of a gripping device is the model 3FG15 by OnRobot, which comprises three arms all connected to a common transmission mechanism within a housing. Each arm has a generally L-shaped body extending in a longitudinal plane, wherein one end is mounted a small disk connected to a rotation shaft of the transmission mechanism. The gripping device has a gripping range of 20-160 mm, however the arms have to be manually moved relative to the disks using tools in order for the gripping fingers to be operated within the full gripping range. Furthermore, the gripping fingers cannot be repositioned on the respective arms.

Gripping devices with similar arms extending in the longitudinal plane are disclosed in CN 103963067A, U.S. Pat. Nos. 4,598,942A and 4,765,669A. In the above gripping devices the gripping process is performed in the radial plane.

JP 2006082140 A describes a gripping tool comprising a drive mechanism arranged with a housing having an interface configured to be coupled to a matching interface of a machine. The gripping tool has three rotatable arms arranged at the opposite end of the housing, each arm has a shell shaped body extending in the radial plane and adapted to be brought into contact with an object. Each arm can be rotated around a rotation axis when activated to bring the arm in or out of contact with the object in the radial plane.

Other gripping devices comprise two or three arms configured to move in the longitudinal plane. The arms may be fitted with one or more joints for moving the gripping fingers into contact with the object.

Therefore a need exists for a gripping or clamping tool with improved flexibility, operating range and lifting capacity.

### OBJECT OF THE INVENTION

An object of the invention is to provide a gripping tool capable of solving the abovementioned problems.

Another object of the invention is to provide a gripping tool that can be operated in the full gripping range.

A further object of the invention is to provide a gripping tool enabling the positions of the gripping fingers to be adjusted without the use of tools.

### DESCRIPTION OF THE INVENTION

An object of the invention is achieved by a gripping tool for handing objects in a process, comprising:
a housing defining a longitudinal axis of the gripping tool,
a drive mechanism arranged with the housing,
an interface arranged at one end of the housing, the interface being configured to be coupled to a matching interface of a machine or to be arranged on a surface,
the plurality of arms being arranged at an opposite end of the housing, each arm comprising at least a first gripping element configured to be brought into contact with the object, each arm is configured to be rotated around a rotation axis when activated, each arm having a body extending in a radial plane from a first end to a second end, the radial plane being perpendicular to the longitudinal axis, wherein the drive mechanism is configured to rotate the at least first gripping element in and out of contact with an object in the radial plane, the body has a first side facing the longitudinal axis and further an opposite second side facing away from the longitudinal axis,
wherein the first side of the body has a first tangent at a first position and a second tangent at a second position, characterised in that the first tangent intersecting the second tangent at an intersecting point, the intersecting point is located within an imaginary circle with a radius extending from the longitudinal axis to the rotation axis of that arm when the arms are in a retracted position.

This provides an alternative design of a gripping tool for robotic or clamping applications having an improved flexibility compared to conventional gripping tools of the same type. The present gripping tool has a compact and lightweight design and provides an increased lifting capacity.

The gripping tool has a protective housing extending in a longitudinal direction from a first end to a second end. The housing further extends in a radial direction and forms an outer surface and an inner surface, wherein the inner surface, the first end and second end together form an internal chamber. The housing may be made of any suitable materials, preferably a lightweight material, e.g. a plastic material, a fibre-reinforced material or metal, e.g. aluminium or stainless steel. The drive mechanism, electrical components and other sensitive components may thus be shielded from dust, moisture, hazardous gasses and other particles found in the environment in which the gripping tool is placed.

The first end may be adapted to form an interface for mounting the gripping tool to a matching interface located on an external machine, as described later. The gripping tool may be mounted onto the robotic arm without the use of tools, e.g. using a screw coupling or a release connection. Alternatively, fasteners may be used to mount the gripping tool to the machine. The interface may further comprise other coupling elements for supplying pressurised air or oil, electrical power and/or control signals to the gripping tool. This saves weight and costs as the gripping tool can be driven by an external energy source. This also allows for simple and quick mounting of the gripping tool.

The first end may be also adapted to form an interface configured to arrange the gripping tool on a surface so that it may function as a clamping tool, as described later. The interface may comprise one or more support elements, mounting elements or fastening elements for enabling the gripping tool to be positioned on the surface. The interface may preferably be shaped as an adaptor or base configured to enable the gripping tool to be correctly orientated relative to the surface. The interface may comprise coupling elements for supplying pressurised air or oil, electrical power and/or control signals to the gripping tool. This saves weight and costs as the gripping tool can be driven by an external energy source. Alternatively, the gripping tool may comprise an internal energy source, e.g. a battery, a photovoltaic cell, or a combination thereof.

The second end may comprise an end plate for closing the internal chamber. Rotation shafts may extend through the end plate to enable the arms to be coupled to the drive mechanism. The openings in the end plate may further be sealed off to prevent dust, moisture, hazarduous gasses and other particles from entering the internal chamber. Alternatively, the arms may be connected to a pin projecting from the end plate and actuators may be coupled to the arms for activating the arms. Linear actuators, hydraulic actuators, pneumatic actuators or electromechanical actuators may be used to rotate the arms around the projecting pin. This allows only electrical cables or fluid hoses to extend through the end plate, thus allowing for a better seal of the end plate.

Each arm has a body extending in the radial plane from a first end to a second end. The first end is configured to be connected to the rotation shaft or projecting pin for enabling the arm to be rotated within the radial plane. The second end forms a free end of the arm. The body further has a top side, a bottom side, a first side and a second side. When placed in a retracted position, the first side is facing towards a central longitudinal axis of the housing and thus the gripping tool. The second side is facing away from the longitudinal axis. At least two arms, preferably three arms, are coupled to the drive mechanism or to individual actuators.

The arms may be arranged relative to the end plate and be able to rotate around a rotation axis defined by the rotation shaft or projecting pin. The rotation axis for each arm may be located at a radial distance from the longitudinal axis, preferably at equal radial distances. The radial plane may be located at a longitudinal distance from the interface of the machine. Due to the compact and lightweight design, this longitudinal distance is reduced to a minimum and thereby allows for a higher lifting capacity.

The gripping tool may be coupled to a tool connecter for mounting multiple of tools, such as multiple gripping tools or a combination of the gripping tool and another tool. Preferably, the tool connector may be configured so that at least two tools can be mounted at the same time, but three, four or more tools may also be mounted. The tool connecter may be arranged between the interfaces of the gripping tool and of the machine. The tool connector may be shaped so that the radial plane of the arms may be arranged perpendicularly to the interface of the machine. Alternatively, the radial plane of the arms may be arranged at an acute angle, e.g. between 30-60 degrees, to the interface of the machine. This allows multiple gripping tools to be connected to the machine at the same time, wherein the gripping tools can be operated simultaneously or individually.

According to one embodiment, the first side has a curved profile extending between the first and second ends or a bend profile defined by at least a first line segment and a second line segment.

The arm has a body where at least at the first side is a convex side facing towards the longitudinal axis. The convex side may be formed by a curved or bending profile. The first side has a first tangent at a first point and a second tangent at a second point, wherein the first and second tangents intersect at an intersecting point. This intersecting point is located within an imaginary circle defined by the radial distance between the longitudinal axis and the rotation axis when the arm is rotated into the retracted position. The intersecting tangents form an obtuse angle α of 90-180 degrees. Unlike the arms of EP 2390068 B1 where the body is bent away from the central longitudinal axis and thus the intersecting point between the tangents of the two flat sides are located at a greater radial distance than the rotation axis of the arm.

The retracted position is defined as the position in which the gripping tool has a minimum gripping distance. The arms can also be rotated into an extended position in which the gripping tool has a maximum gripping distance. The minimum and maximum gripping distances together define the gripping range of gripping tool.

The body of the arm may have an overall curved profile where one or both of the first and second sides have a curved surface profile. The arm may in example have an annular segment shaped body. Alternatively, the first side may have a greater curvature than the second side. The arm may thus have a slender body profile with a reduced weight.

The body may also have an overall bending profile where one or both of the first and second sides have a bending surface profile. The first side and/or the second side may in example have a first line segment and a second line segment interconnected at a bend line. The first and second line segments may be straight lines. Optionally, a central line segment may be arranged between the first and second line segments. The central line segment may be a curved line. The arm may thus have a slender body profile with a reduced weight.

Alternatively, the body may have a curved or bending first side and a straight second side. The arm may thus have an overall triangular, arc or elliptical segment shaped body. This provides a body profile with increased structural strength and thus allows for a greater clamping or gripping force.

The arms and/or the gripping elements may be made of any suitable material, preferably a lightweight material, e.g. a plastic material, a fibre-reinforced material or metal, e.g. aluminium or stainless steel. However, other materials may also be used.

According to one embodiment, at least a second gripping element is arranged on the arm, wherein the second gripping element is arranged at an intermediate position between the first and second ends of the arm.

The number of gripping elements on each arm may be selected depending on the particular application and the dimensions of the objects. In example, a single gripping element may be arranged on the arm. Alternatively, two, three or more gripping elements may be arranged on the arm. The gripping elements may extend perpendicularly relative to the radial pane, or be placed at an angle relative to the radial plane.

Optionally, the free end, e.g. the second end, of the arm may also act as a gripping element. In this embodiment, no further gripping elements may be arranged on the arm. Alternatively, one or more further gripping elements may be arranged on the arm at intermediate position(s). This design may be preferred for applications where the robot unit is handling large objects.

The local position of the gripping element(s) on the arm may be adapted to the particular applications and the dimensions of the objects.

A first gripping element may be arranged at an outermost position on the arm, e.g. at the second end. This allows the gripping tool to grip large objects.

Alternatively or additionally, one or more second gripping elements may be arranged at one or more intermediate positions on the arms. This allows the gripping tool to grip small and medium-sized objects.

In example, the first gripping element may be arranged at the second end and the second gripping element may be arranged at a selected intermediate position. In example, both the first and second gripping elements may be arranged at different intermediate positions. This allows the gripping tool to grip objects of different sizes and shapes.

Here, the intermediate position(s) is/are defined as any position between the first and second ends of the arm. The position located at the second end or closest to the second end defines an outermost position. The position located closest to the first end defines an innermost position.

According to one embodiment, at least the first gripping element is releasable connected to the arm by a mechanical coupling, preferably a quick release fastener or a clamping element.

The gripping element(s) may be firmly connected to the arm, e.g. forming an integrated part of the arm. This allows the gripping element(s) and arm to be manufacturing in one piece, but the gripping element(s) cannot be repositioned. Thus, the free end of the arm may alternatively be used as another gripping element, or a kit of arms with different lengths and/or different gripping elements may be used.

Preferably, the gripping element(s) may be releasable connected to the arm. The arm may comprise one, two, three or more mounting positions for the gripping elements. The gripping element may comprise a first connecting part and the arm may comprise a second connecting part, wherein the first and second connecting parts can be releasable connected to each other. Thereby, allowing the gripping element to be repositioned on the arm and/or replacement of the gripping element.

In example, the release connection may be a threated coupling, a snap-fit coupling, a quick release fastener or a spring-loaded coupling. Other types of release connections may also be used, such as a clamping element for applying a clamping force to the arm.

This allows for the gripping element to be repositioned or replaced without the use of tools. Such release connections are known and will not be described in details.

In conventional gripping tools, e.g. 3FG15 from OnRobot, the gripping fingers are repositioned by adjusting the position of the arm relative to the disk using tools.

According to one embodiment, the first gripping element has a first height measured in the longitudinal direction and the second gripping element has a second height measured in the longitudinal direction, wherein the first height equals to or differs from the second height.

The gripping element may have a height measured in the longitudinal direction from a top surface of the arm to a free end surface of the gripping element. The gripping element may further have a width, e.g. a diameter, in the radial direction. The dimensions and profile of the gripping element may be selected dependent on the particular application and the objects to be handled.

Further, the gripping finger may be covered with a soft material, a material with a higher friction coefficient than the rest of the gripping element, or a material with a rough surface or a surface microstructure. Alternatively, the gripping element may be made of a soft material, a material with a high friction coefficient, or a material with a rough surface or a surface microstructure. Such materials are known to the skilled person and will not be described in further details.

If the arm is fitted with more than one gripping element, then the first and second gripping element may have equal heights. Alternatively, the first gripping element has a first height and the second gripping element has a second height. The first height is lower than the second height, or vice versa.

Optionally, a kit of gripping elements may be used together with the gripping tool, where the individual gripping elements have different heights and/or different profiles.

According to one embodiment, the arms in the retracted position are positioned relative to each other so that
at least one gripping element on each arm is contacting each other, and/or
the first side of one arm is at least partly contacting the first side of an adjacent arm.

In a special embodiment of the invention, the arms may be designed so that, when rotated into the retracted position, a selected set of gripping elements on the arms are contacting each other. Alternatively or additionally, the first side of one arm may partly contact the second side of an adjacent arm.

Optionally, the arms may be positioned so that a small gap, e.g. of a few millimetres, is formed between the adjacent arms.

The contact surfaces between the individual gripping elements may be adapted to increase the contact surface area in order to reduce the wear on the gripping elements.

According to one embodiment, the at least first gripping element is configured to be operated within a full gripping range of the gripping tool while maintaining each arm in the same radial position relative to each rotation axis.

Unlike conventional gripping tools, the present gripping tool may be operated within the full gripping range of gripping tool without having to adjust the radial positions of the arms. Furthermore, the positions of the gripping fingers may be adjusted without the use of tools.

This may be achieved by providing more than one gripping element on the respective arms, where an innermost gripping element may be rotated into a minimum gripping position and an outermost gripping element may be rotated into a maximum gripping position. The minimum and maximum gripping positions define together the maximum or full gripping range of the gripping tool.

This may also be achieved by simply adjusting the position of the gripping element on the arm via the quick release connection. Thereby, allowing the gripping element to be repositioned on the arm in a quick and simple manner without the use of tools.

The gripping tool may have a first gripping range when the gripping elements are moved into contact with an exterior surface of the object. Further, the gripping tool may have a second gripping range when the gripping elements are moved into contact with an interior surface of the object.

According to one embodiment, the at least first gripping element is shaped as a finger projecting from a top side of the arm or an elongated gripping element extending along the top side of the arm.

Preferably, the gripping element may be shaped as a gripping finger having a predetermined cross-section and a predetermined profile along its longitudinal axis. The gripping finger may have any suitable cross-sectional profile and/or longitudinal profile.

In example, the gripping finger may have a circular, elliptic, polygonal, triangular, rectangular or another suitable cross-section. The griping element may have a constant profile along its longitudinal axis, alternative the profile may vary along the longitudinal axis. This allows the gripping finger to have a body adapted to contact one or more desired types of objects.

The gripping element may also be shaped as an elongated gripping element extending along the arm from a local first end to a local second end. This elongated gripping element may extend partly or fully along the length of the arm. The elongated gripping element may further have a local first side, a local second side and a local top side. This allows for an alternative design of the gripping element.

The elongated gripping element may have a height that tapers from the local first end to the local second end, or vice versa. The local top side may thus be angled relative to the top side of the arm. Alternatively, the elongated gripping element may have a stepped profile extending from the local first end to the local second end, or vice versa. The local top side may thus form a plurality of steps each having a predetermined height and length. The stepped profile may be selected dependent on the particular application and objects intended to be handled.

According to one embodiment, the at least first gripping element can be selectively arranged in a plurality of individual positions on the arm and/or in an elongated positioning element on the arm.

The arms may comprise a plurality of positions for selective positioning the gripping fingers or elongated element relative to the arm. Preferably, two, three, four or more positions may be distributed along the length of the arm. In example, one gripping finger may be firmly connected in one position, e.g. at the second end, and one or more additional griping fingers may be selectively arranged at one or more of the other positions. In example, all of the one or more gripping fingers may be selectively arranged at one or more of the positions. In example, the elongated gripping element may extend over multiple positions and be selectively connected to the arm at two or more positions.

The gripping element may comprise a male connection part and the arm may comprise a female connection part, or vice versa. The female connection part may be formed as a cavity (non-through hole) or a through hole, e.g. with an internal threat or a first snap-fit element. The male part may be formed as a projecting element, e.g. with an external threat or a second snap-fit element. The first snap-fit element may be configured to engage the second snap-fit element. This allows for a quick and easy insertion and removal of the gripping element.

The arm may also comprise an elongated positioning element where the gripping element(s) may be selectively arranged at any position along this positioning element. The positioning element may be a cavity (non-through hole) or a through hole. The gripping element(s) may be held in a selected position by friction, a press-fit, a clamping force, a spring force or other means. This also allows the gripping element to be selectively arranged along the length of the arm.

Alternatively, the positioning element may comprise a box joint comprising a plurality of slots each of which defines a selective position for the gripping element. The male connection part of the gripping finger may comprise a retracted or flat portion so that the gripping finger may be turned and pushed from one slot to another slot. The gripping finger may then be turned back to lock the gripping finger in that position. If the elongated gripping element comprises two or more male parts, the male parts may be pulled out of one set of slots and then pushed into another set of slots.

The gripping tool may be configured to grip objects of different sizes and shapes. The objects may have a circular or elliptical cross section, or a polygon shaped cross section. These objects may suitable be gripped by the gripping fingers contacting the exterior surface of the object.

The gripping tool may also be configured to grip objects by rotating the gripping fingers into contact with an internal surface of the object. Such objects may have an annular or ring shaped profile. The object may also comprise an open-ended spacing, e.g. a cavity or a through hole, where the gripping fingers are contacting an inner surface of that spacing.

An object of the invention is also achieved by a system configured to handle objects in a process, comprising:
a machine configured to process an object,
the machine comprises at least one interface configured to be coupled to at least one gripping tool as described above,
the machine further comprises an energy source for supplying power to the gripping tool and a controller configured to at least control the operation of the gripping tool.

This provides a system with improved gripping flexibility and increased lifting capacity. The present gripping tool is able to grip objects of different sizes and shapes.

The machine comprises a matching interface configured to be coupled to the interface of the above gripping tool. This interface may further comprise electrical coupling elements and/or hose coupling elements for connecting the drive mechanism of the gripping tool to an energy source in the machine, alternatively to an energy source coupled to the machine. The energy source may be configured to provide pneumatic, hydraulic or electrical power to the gripping tool. This allows the gripping tool to be powered by the machine or an external energy source.

The machine further comprises a controller configured to at least control the operation of the gripping tool. The machine may be fitted with suitable means for manipulating, working and/or treating the object. The operation of these means may also be controlled by the controller. The gripping tool may load the object into machine, hold the object during the process, and/or unload the processed object from the machine. The machine may be any machine in which a gripping tool is used and where either a process is performed on the object or the object forms part of the process.

Optionally, the controller may be electrically connected to one or more sensors in the gripping tool via the interfaces. The controller may use these sensor signals to control the axial movement of the gripping tool and/or the activation of the gripping elements.

According to one embodiment, the machine is a robot unit with at least one robotic arm, wherein the robotic arm extends from a base end to a free end, the matching interface being located at the free end of the robotic arm.

The robot unit comprises one or more robotic arms each extending from a base end to a free end. The robotic arm may comprise one or more joints so that it is able to move in multiple axial directions. The robot unit further comprises a controller configured to control the operation of the robot and also the gripping tool attached to the robotic arm. Means for powering the robot as well as the gripping tool, e.g. an electrical power source, a pneumatic energy source or a hydraulic energy source, may be arranged on the robot unit or be coupled to the robot unit. The robot tool may thus have a compact and lightweight configuration.

The controller may be connected to a user interface configured to enable a worker, or an artificial intelligence (AI), to program and/or operate the robot unit. The user interface may be a user terminal located on the robot unit. The user interface may also be a remote terminal or computing device. The robot unit may be programmed and operated using known techniques or an AI system.

The machine, or robot unit, may be fitted one or more sensors for sensing the axial movement of the tool. The sensor may be an accelerometer, a gyroscope or another suitable sensor. This allows the controller to monitor the axial movement of the robotic arm and thus the tool based on signals from these sensors.

Alternatively or additionally, the gripping tool may be fitted with one or more sensors for detecting the position of the gripping tool relative to an object. The sensors may be a vision sensor, a tactile sensor, an ultrasonic sensor, a proximity sensor, a force torque sensor or another suitable sensor. These sensors may be electrically connected to the controller via the interfaces. This allows the controller to correctly position the gripping tool relative to the object based on the sensor signals. The controller may optionally use two- or three dimensional maps of the objects to correctly position the gripping tool.

The controller may adjust the position of the gripping tool so that it is aligned with a centre of gravity of the object. The controller may use the signal from the force torque sensor to detect any misalignment between the gripping tool and the object and/or any loads extending the safety thresholds. The controller may then reposition the gripping tool accordingly. Alternatively, objects may be gripped even if the gripping tool is misaligned. The local controller may then compensate for this misalignment by adjusting orientation of object.

An object of the invention is further achieved by a clamping unit configured to handle objects in a process, the clamping unit being configured to be arranged on a surface, the clamping unit comprising:
a gripping tool as described above,
a local controller configured to control the operation of the gripping tool, wherein the controller is electrically connected to at least one of a remote user interface or a local user interface,
at least one of a local energy source or coupling elements configured to be connected to an external energy source, the local or external energy source being configured to supply power to the clamping unit.

This provides a clamping tool with improved gripping flexibility and increased lifting capacity. The present gripping tool is able to grip objects of different sizes and shapes. The clamping tool is adapted to be arranged on different surfaces for easy placement of the clamping tool.

The clamping tool has a local controller arranged in the gripping tool, e.g. in the housing. The local controller is configured to control the operation of the gripping tool and is electrically connected to the energy source. The local controller may be a microprocessor, an electrical circuit, a programmable logic circuit or another suitable controller. The local controller may further be electrically connected to the sensors in the gripping tool mentioned earlier, wherein the local controller uses these sensor signals to control the operation of the gripping tool.

The clamping tool further has an internal energy source, e.g. a battery or photovoltaic cell, for powered the gripping tool and the electrical components thereof. Alternatively or additionally, the clamping tool may comprise coupling elements for connecting the clamping tool to an external energy source, e.g. the power grid. This allows the clamping tool to be configured as a stand-alone unit.

According to one embodiment, the clamping unit further comprises an adapter element having a bottom surface shaped to be arranged on the surface, the adapter element further has a top surface configured to be coupled to or integrated into the interface of the gripping tool.

The housing, and optionally the first end, of the gripping tool may be made of a heavy material, such as cast iron or steel, or have an increased wall thickness. The first end forming the interface may thus be shaped to be simply placed onto a particular surface, e.g. of a table.

The first end may also be shaped as a bracket configured to be mounted onto the surface by fasteners, or the bracket may be fixed to surface using clamps. The first end may alternatively comprise suction cups, high friction pads, magnets and/or spikes. This allows the clamping tool to be placed on a low friction surface, an inclined surface or even a vertical surface.

The clamping tool may further comprise an adapter element configured to be attached to the first end of the gripping tool, alternatively the adapter element may be integrated into the first end. The adapter element may have a bottom side shaped to be brought into contact with the surface. The adapter element may further have a top side shaped to be attached to the gripping tool or shaped to form the first end of the housing of the gripping tool.

The bottom side and top side may be arranged in parallel or arranged at an angle so that the gripping tool is tilted relative to the surface. The adapter element may comprise an adjustable mechanism so that the top side can be tilted around one or more tilting axis. This allows the object to be placed in an optimal position for processing the object.

The clamping tool further comprises a user interface configured to enable a worker to operate the gripping tool. The user interface may be a user terminal, a graphical user interface, push buttons or another suitable user interface. Alternatively or additionally, the clamping tool may comprise a wireless transceiver, e.g. an antenna, adapted to wirelessly communicate with a remote device, e.g. a user terminal or a computing device. The computing device may be a tablet, a smartphone, a laptop, a PDA, a phablet or another suitable computing device. A computing program, or application, may be configured to run on the computing device may thus communicate with the local controller via suitable control signals. This allows the worker to operate the gripping tool, preferably in an intuitive manner.

An object of the invention is further achieved by a method of handling objects in a process using a system or a clamping unit with a gripping tool as described above, comprising the steps of:
moving either the gripping tool into position relative to a selected object or the object into position relative to the gripping tool,
activating the gripping tool to rotate the gripping fingers in a radial plane into contact with the selected object,
performing a process on the object or a process that involves the object,
further activating the gripping tool to rotate the gripping fingers out of contact with the selected object in the radial plane.

This provides a method of manipulating objects where the gripping tool is able to grip objects of different sizes and shapes. This increases the flexibility of the gripping tool as no tools are needed to adapt the gripping fingers to specific objects. This also increases the gripping capacity compared to conventional gripping tools as the distance between the radial plane of the arms and the interface of the machine is reduced to a minimum, thus reducing the bending moment.

The objects may be fed into a loading position relative to the machine, either individually or in groups. The gripping tool may then be moved into position relative to a selected object. The gripping elements may be rotated into an open position by the drive mechanism, e.g. prior or during the positioning of the gripping tool. The gripping tool may be moved further towards the object and the gripping elements may be moved into contact with the object to apply a gripping force.

The object may then be lifted out of its position and manipulated by the machine into a new position and/or orientation. The gripping tool may be moved further towards an unloading position. The gripping elements may then be moved out of contact with the object and the gripping tool may be moved away from the object. Optionally, the gripping tool may be moved back to the loading position for picking up a new object.

The object may instead be moved into position relative to the gripping tool. The gripping elements may be rotated into an open position prior to positioning the object. The gripping elements may afterwards be rotated into contact with the object. The object may then undergo a suitable process while being held in place by the clamping tool. The gripping elements may subsequently be rotated out of contact with the object and the processed object may be removed from the gripping tool.

### DESCRIPTION OF THE DRAWING

The invention is described by example only and with reference to the drawings, wherein:

FIG. 1 shows an exemplary embodiment of a robot unit with a gripping tool,

FIG. 2 shows the robot unit of FIG. 1 with an object,

FIG. 3 shows a side view of the robot unit with the object,

FIGS. 4a-b show a first embodiment of the arms with gripping fingers in a retracted position and in an extended position,

FIGS. 5a-b show a second embodiment of the arms with gripping fingers in a retracted position and in an extended position,

FIG. 6 shows the arm with two positions for placement of the gripping finger,

FIG. 7 shows a second embodiment of the arm having a triangular body,

FIG. 8 shows a third embodiment of the arm having a curved body,

FIG. 9 shows a fourth embodiment of the arm with multiple positions for placement of the gripping finger,

FIG. 10 shows the arm with a first gripping finger and a second gripping finger being shorter than the first gripping finger,

FIG. 11 shows the arm with a first gripping finger and a second gripping finger being greater than the first gripping finger,

FIGS. 12a-f show six alternative embodiments of the gripping finger,

FIG. 13 shows the arm with an alternative embodiment of the gripping finger,

FIGS. 14a-b show a first embodiment of an elongated gripping element arranged on the arm,

FIGS. 15a-b shows a second embodiment of the elongated gripping element arranged on the arm,

FIG. 16 shows a fifth embodiment of the arm with an elongated positioning element,

FIG. 17 shows an alternative embodiment of the elongated positioning element,

FIG. 18 shows a clamping tool with the gripping tool holding an object, and

FIG. 19 shows a tool connecter for mounting multiple tools.

In the following text, the figures will be described one by one and the different parts and positions seen in the figures will be numbered with the same numbers in the different figures. Not all parts and positions indicated in a specific figure will necessarily be discussed together with that figure.

### REFERENCE LIST

1. Robot unit
2. Gripping tool
3. Robotic arm
4. Base
5. Local controller
6. Objects
7. Housing
8. First interface
9. Second interface
10. Transmission mechanism
11. Arms
12. Gripping fingers
12a. First gripping finger
12b. Second gripping finger
13. Second end
14. Body
15. First end
16. Second end
17. First side
18. Second side
19. Rotation shaft
20. Outermost position
21. Intermediate position
22. Intersecting point
23. Bottom side
24. Top side
25. Gripping finger
26. Releasable connection
27. Arm
28. Elongated gripping element
29. Local top side
30. Local second end
31. Local first end
32. Arm
33. Elongated positioning element
34. Slots
35. Clamping unit
36. Surface
37. Adapter element
38. Tool connecter

### DETAILED DESCRIPTION OF THE INVENTION

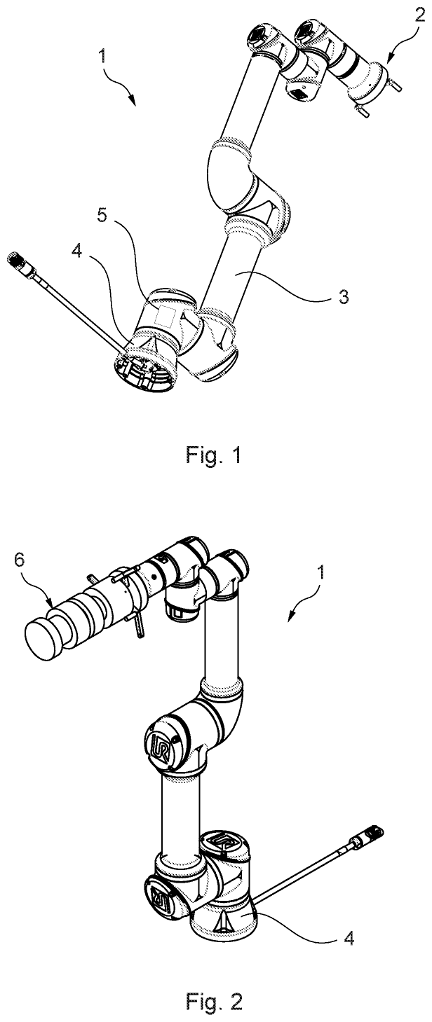

FIG. 1 shows an exemplary embodiment of a robot unit 1 with a gripping tool 2 mounted to a robotic arm 3 of the robot unit 1. Here, the robotic arm 3 extends from a base 4 to a free end at which the interface 9 is arranged. The robot unit 1 further comprises a local controller 5 configured to control the operation of the robotic arm 3 and the gripping tool 2.

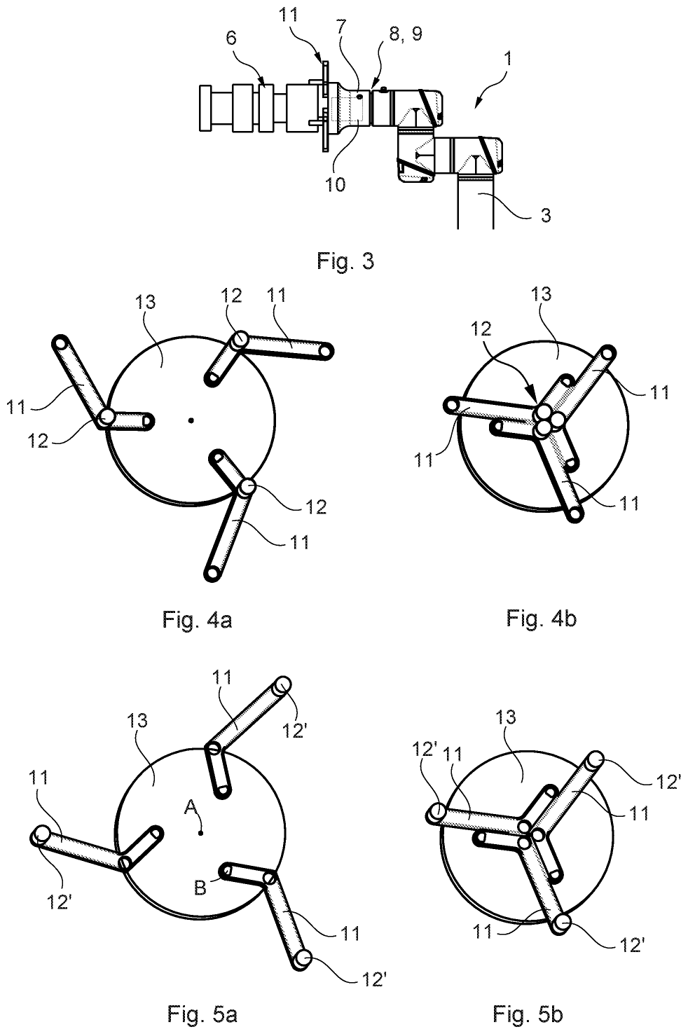

FIGS. 2 and 3 show the robot unit 1 with an object 6 gripped by the gripping tool 2. The gripping tool 2 comprises a housing 7 having a first end and an opposite second end. The first end is formed as first interface 8 configured to be mounted to a matching second interface 9 of the robotic arm 3. A transmission mechanism 10 is arranged inside the housing 7 and connected to a number of arms 11 via individual rotation shafts (not shown). The transmission mechanism 10 is further configured to receive power via the first and second interface 8, 9.

As indicated in FIG. 3, the arms 11 form a radial plane in which each arm is rotated around a rotation axis defined by the rotation shaft thereof. The radial plane is perpendicular to a longitudinal axis (shown in FIG. 4a) of the gripping tool 2 extending through the first and second ends. The radial plane is arranged at a minimum distance from another radial plane defined by the first and second interfaces 8, 9.

FIGS. 4a-b show a first embodiment of the arms 11 each fitted with a gripping finger 12 arranged at an intermediate position on the arm 11. FIG. 4a shows the arms 11 and gripping fingers 12 rotated into an extended position while FIG. 4b shows the arms 11 and the gripping fingers 12 rotated into a retracted position.

The arms 11 and gripping fingers 12 are rotated relative to the second end 13 of the housing 7 within the radial plane. In FIG. 4a, the gripping fingers 12 are rotated to an extended position indicating a local maximum gripping position. In FIG. 4b, the gripping fingers 12 are rotated to a retracted position where the gripping fingers 12 are brought into contact with each other. This position indicates a minimum gripping position of the gripping tool 2.

FIGS. 5a-b show a second embodiment of the arms 11 each fitted with a gripping finger 12′ arranged at an outermost position on the arm 11. FIG. 5a shows the arms 11 and gripping fingers 12′ rotated into an extended position while FIG. 5b shows the arms 11 and the gripping fingers 12′ rotated into a retracted position.

The arms 11 and gripping fingers 12′ are rotated relative to the second end 13 of the housing 7 within the radial plane. In FIG. 5a, the gripping fingers 12′ are rotated to an extended position indicating a maximum gripping position of the gripping tool 2. In FIG. 5b, the gripping fingers 12′ are rotated to a retracted position where the arms 11 partly parallel to each other. This position indicates a local minimum gripping position.

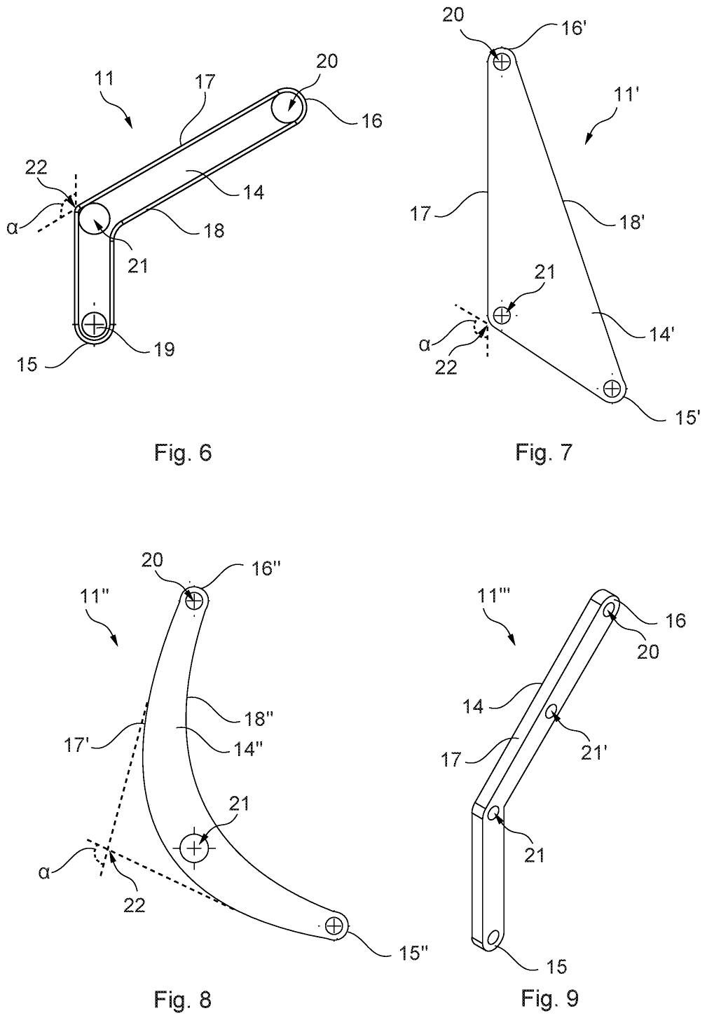

FIG. 6 shows a first embodiment of the arm 11 where the arm 11 has a body 14 extending in the radial plane. Here, the arm 11 has a bending profile. The body 14 extends from a first end 15 to a second end 16, and has a first side 17 and a second side 18. The first end 15 is connected to the rotation shaft 19 which defines a rotation axis for that arm 11.

The arm 11 has a first or outermost position 20 for placement of the gripping finger 12, as indicated in FIGS. 5a-b. The arm 12 further has a second or intermediate position 21 for an alternative placement of the gripping finger 12, as indicated in FIGS. 4a-b.

The first side 17 is formed by a first line segment and a second line segment intersecting each other at an intersecting point 22. Here, the intersecting point 22 is formed by the bending line of the first side 17. The two line segments form an obtuse angle α. This intersecting point 22 is located within an imaginary circle with a radius extending from the central longitudinal axis, A, to the rotation axis, B, of the arm 11, as indicated in FIG. 5a.

FIG. 7 shows a second embodiment of the arm 11′ having a triangular body 14′. The first side 17 is also formed by two line segments having an obtuse angle α at the bending line. The second side 18′ is formed by a straight line extending between the first and second ends 15′, 16′.

FIG. 8 shows a third embodiment of the arm 11″ having a curved body 14″. Here the first side 17′ has a curved surface profile extending from the first end 15″ to the second end 16″. The second side 18″ also has a curved surface profile extending from the first end 15″ to the second end 16″. The first side 17′ has a first tangent at a first position and a second tangent at a second position, where the two tangents intersect at the intersecting point 22. The two tangents form an obtuse angle α.

The first position is preferably located at or near the first end 15″. The second position is preferably located at or near the second end 16″.

FIG. 9 shows a fourth embodiment of the arm 11′ with multiple positions for placement of the gripping finger 12. Here, three positions are shown, but the arm 11″ may comprise additional positions.

An outermost position is located at the second end 16 while an innermost position is located towards the first end 15, e.g. at the bending.

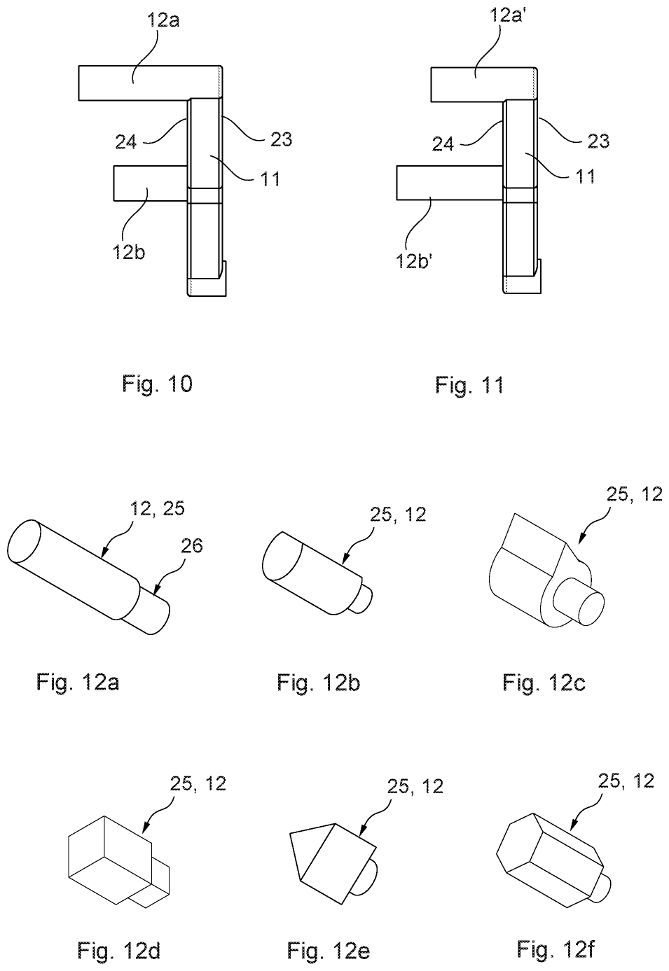

FIG. 10 shows the arm 11 with a first gripping finger 12a arranged at the second end 16. A second gripping finger 12b is further arranged at the intermediate position 21. The arm 11 has a thickness measured between a bottom side 23 and a top side 24. The first gripping finger 12a has a first height measured from the top side 24 to an end surface of the gripping finger 12a. The second gripping finger 12b has a second height measured from the top side 24 to an end surface of the gripping finger 12b. Here, the first height is greater than the second height.

FIG. 11 shows the arm 11 with another first gripping finger 12a′ arranged at the second end 16. Another second gripping finger 12b′ is further arranged at the intermediate position 21. The first gripping finger 12a′ has a first height measured from the top side 24 to an end surface of the gripping finger 12a′. The second gripping finger 12b′ has a second height measured from the top side 24 to an end surface of the gripping finger 12b′. Here, the second height is greater than the first height.

FIG. 12a-f show six alternative embodiments of the gripping finger 25. Here, the gripping finger 25 is a separate finger configured to be mounted to the arm 11 at a selected position 20, 21, 21′ via a releasable connection 26. Here, the releasable connection 26 is a quick release fastener.

In example, the first gripping finger 12a may be firmly connected to the arm 11 while the second gripping finger 12b may be releasable connected to the arm 11, or vice versa. Alternatively, both the first and second gripping fingers 12a, 12b may be releasable connected or firmly connected to the arm 11.

In FIG. 12a, the gripping finger 12, 25 has a circular cross-sectional profile. The gripping finger 12, 25 has in FIG. 12b a circular cross-sectional profile with a flat sub-surface for contacting an adjacent gripping finger 12, 25 when rotated into the retracted position. In FIG. 12c, instead of a flat sub-surface the gripping finger 12, 25 have a projecting portion. Here, the projecting portion has a triangular shape, but other shapes may be used.

The gripping finger 12, 25 has in FIG. 12c a squared or rectangular cross-sectional profile. The gripping finger 12, 25 has in FIG. 12d a triangular cross-sectional profile. Finally, the gripping finger 12, 25 has in FIG. 12e a polygonal cross-sectional profile.

Although the gripping finger 12, 25 in FIGS. 12a-e has a constant profile along the height, the profile of the gripping finger 12, 25 may vary along the height. In example, the gripping finger 12, 25 may have cone-shaped or tapered profile in height direction.

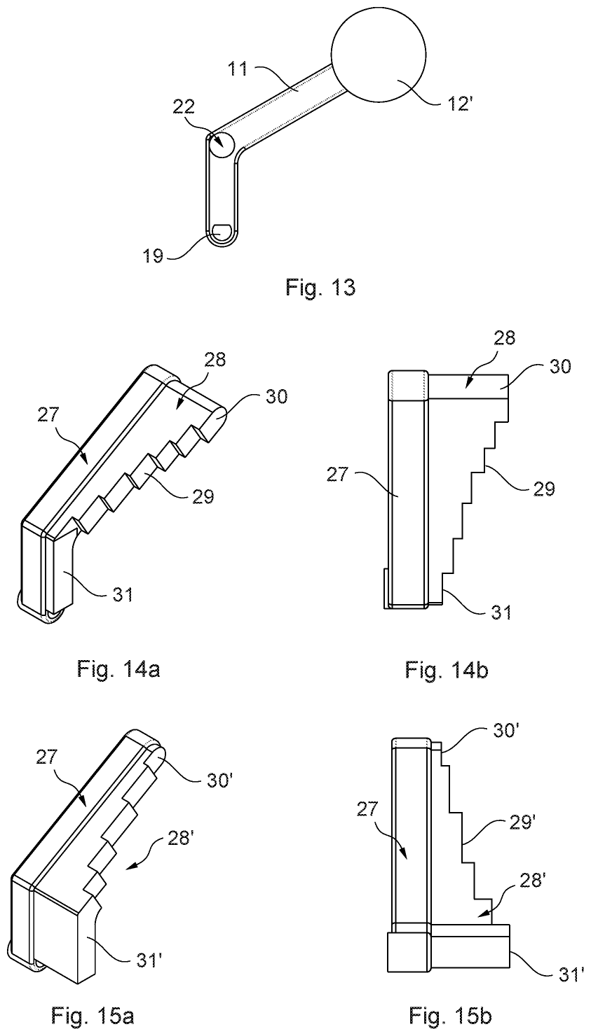

FIG. 13 shows the arm 11 with an alternative embodiment of the gripping finger 12′, where the gripping finger 12′ has an increased cross-sectional profile compared to the cross-sectional profile shown in FIGS. 4a-5b. Here, the diameter of the gripping finger 12′ is greater than the thickness of the arm 11.

FIGS. 14a-b show a first embodiment of an elongated gripping element 28 arranged on the arm 27. Here the elongated gripping element 28 is integrated with arm 27 to form a single piece, but the elongated gripping element 28 may also be release connected to the arm 27 as mentioned above.

The elongated gripping element 28 extends along the top side 24 of the arm 27 from a local first end 31 to a local second end 30. The elongated gripping element 28 has a height measured from the top side 24 to a local top side 29. Here, the elongated gripping element 28 has stepped profile that tapers from the local second end 30 to the local first end 31.

FIGS. 15a-b shows a second embodiment of the elongated gripping element 28′ arranged on the arm 27. Here, the elongated gripping element 28′ has stepped profile that tapers from the local first end 31 to the local second end 30.

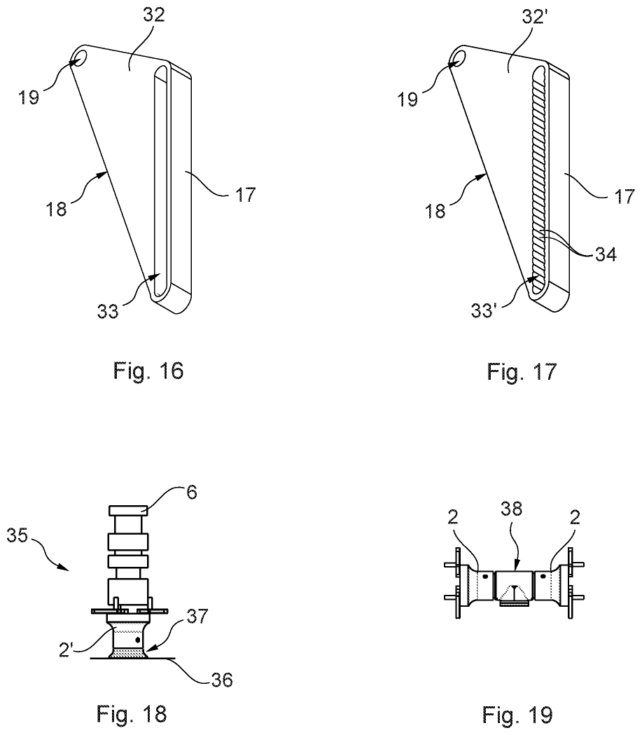

FIG. 16 shows a fifth embodiment of the arm 32 with an elongated positioning element 33. Here the elongated positioning element is formed as an elongated through hole.

The gripping fingers 12, 25 or the gripping element 28 can be selectively arranged in any position along the length of the elongated positioning element 33. The gripping finger 12, 25 or the gripping element 28 is here held in a selected position by friction, a press-fit or clamps.

FIG. 17 shows an alternative embodiment of the elongated positioning element 33′ on the arm 32′. Here the elongated positioning element 33′ comprises a plurality of slots 34 each defining a selective position for the gripping finger 12, 25 or the gripping element 28. The gripping finger 12, 25 or the gripping element 28 is here held in place by a box joint.

FIG. 18 shows a clamping unit 35 with the gripping tool 2′ holding an object 6 where the clamping unit 35 is arranged on a surface 36. The clamping unit 35 comprises an adapter element 37 configured to be placed on the surface 36 and to be coupled to the first end of the gripping tool 2′.

The clamping unit 35 has an internal energy source powering the gripping tool 2′ and a user interface (not shown). The user interface is electrically connected to a local controller arranged inside the clamping unit 35. The operation of the gripping tool is controlled by the local controller.

FIG. 19 shows a tool connecter 38 for mounting multiple tools, preferably multiple gripping tools 2. The tool connecter 38 is configured to be mounted to a machine, preferably the robotic arm 3 of the robot unit 1.

1. A gripping tool for handling objects in a process, comprising:
a housing defining a longitudinal axis (A) of the gripping tool,
a drive mechanism arranged with the housing,
an interface arranged at one end of the housing, the interface being configured to be coupled to a matching interface of a machine or to be arranged on a surface,
a plurality of arms being arranged at an opposite end of the housing, each arm comprising at least a first gripping element configured to be brought into contact with the object, each arm is configured to be rotated around a rotation axis (B) when activated, each arm having a body extending in a radial plane from a first end to a second end, the radial plane being perpendicular to the longitudinal axis (A), wherein the drive mechanism is configured to rotate the at least first gripping element in and out of contact with the object in the radial plane, the body has a first side facing the longitudinal axis and further an opposite second side facing away from the longitudinal axis,
wherein the first side of the body has a first tangent at a first position and a second tangent at a second position, wherein the first tangent intersecting the second tangent at an intersecting point, the intersecting point is located within an imaginary circle with a radius extending from the longitudinal axis (A) to the rotation axis (B) of that arm when the arms are in a retracted position.

2. The gripping tool according to claim 1, wherein the first side has a curved profile extending between the first and second ends or a bending profile defined by at least a first line segment and a second line segment.

3. The gripping tool according to claim 1, wherein at least a second gripping element is arranged on the arm, wherein the second gripping element is arranged at an intermediate position between the first and second ends of the arm.

4. The gripping tool according to claim 1, wherein at least the first gripping element is releasable connected to the arm by a mechanical coupling, preferably a quick release fastener or a clamping element.

5. The gripping tool according to claim 3, wherein the first gripping element has a first height measured in the longitudinal direction and the second gripping element has a second height measured in the longitudinal direction, wherein the first height equals to or differs from the second height.

6. The gripping tool according to claim 1, wherein the arms in the retracted position are positioned relative to each other so that
at least one gripping element on each arm is contacting each other, and/or
the first side of one arm is at least partly contacting the first side of an adjacent arm.

7. The gripping tool according to claim 1, wherein the at least first gripping element is configured to be operated within a full gripping range of the gripping tool while maintaining each arm in the same radial position relative to each rotation axis (B).

8. The gripping tool according to claim 1, wherein the at least first gripping element is shaped as a finger or an elongated gripping element extending outwards from a top side of the arm.

9. The gripping tool according to claim 1, wherein the at least first gripping element can be selectively arranged in a plurality of individual positions on the arm and/or in an elongated positioning element on the arm.

10. A system configured to handle objects in a process, comprising:
a machine configured to process an object,
the machine comprises at least one interface configured to be coupled to at least one tool, the at least one tool being a gripping tool according to claim 1,
the machine further comprises an energy source for supplying power to the gripping tool and a controller configured to at least control the operation of the gripping tool.

11. The system according to claim 10, wherein the machine is a robot unit with at least one robotic arm, wherein the robotic arm extends from a base end to a free end, the matching interface being located at the free end of the robotic arm.

12. A clamping unit configured to handle objects in a process, the clamping unit being configured to be arranged on a surface, the clamping unit comprising:
a gripping tool according to claim 1,
a local controller configured to control the operation of the gripping tool, wherein the controller is electrically connected to at least one of a remote user interface or a local user interface,
at least one of a local energy source or coupling elements configured to be connected to an external energy source, the local or external energy source being configured to supply power to the clamping unit.

13. The clamping unit according to claim 12, wherein the clamping unit further comprises an adaptor element having a bottom surface shaped to be arranged on the surface, the adaptor element further has a top surface configured to be coupled to or integrated into the interface of the gripping tool.

14. A method of handling objects in a process using a system according to claim 10, comprising the steps of:
moving either the gripping tool into position relative to a selected object or the object into position relative to the gripping tool,
activating the gripping tool to rotate the gripping fingers in a radial plane into contact with the selected object,
performing a process on the object or a process that involves the object, further activating the gripping tool to rotate the gripping fingers out of contact with the selected object in the radial plane.

15. A method of handling objects in a process using a clamping unit according to claim 12, comprising the steps of:
moving either the gripping tool into position relative to a selected object or the object into position relative to the gripping tool,
activating the gripping tool to rotate the gripping fingers in a radial plane into contact with the selected object,
performing a process on the object or a process that involves the object,
further activating the gripping tool to rotate the gripping fingers out of contact with the selected object in the radial plane.
